(19) United States
(12) Patent Application Publication
(10) Pub. No.: US 2021/0075745 A1
(43) Pub. Date: Mar. 11, 2021

(54) METHODS AND APPARATUS FOR IMPROVED POLLING EFFICIENCY IN NETWORK INTERFACE FABRICS

(71) Applicant: GigaIO Networks, Inc., Carlsbad, CA (US)

(72) Inventor: Eric Badger, Carlsbad, CA (US)

(21) Appl. No.: 17/016,269

(22) Filed: Sep. 9, 2020

Related U.S. Application Data
(60) Provisional application No. 62/898,489, filed on Sep. 10, 2019.
(60) Provisional application No. 62/909,629, filed on Oct. 2, 2019.

(51) Int. Cl. H04L 12/861; H04L 12/26

(52) U.S. Cl. CPC H04L 49/9005; H04L 43/10

(57) ABSTRACT

Methods and apparatus for improved polling efficiency in networks such as those with interface fabrics. In one exemplary embodiment, the methods and apparatus provide efficient alternatives to linear or other polling methods by allocating queues (whether statically or dynamically) to groups or sets of queues based on one or more attributes associated therewith. Higher priority queue sets or groups are polled according to a different scheme than those in other, lower priority groups, thereby providing significant economies relative to a process where all queues are checked by rote each polling increment. In another disclosed approach, a flag is associated with each queue (or subset of all queues) which indicates to a reading process that the queue has been written since its last poll. In one variant, the queue flags comprise a single byte, and the queues are “tiered” such that one flag can be used to represent multiple queues.

### PRIORITY AND RELATED APPLICATIONS

This application claims the benefit of priority to U.S. Provisional Patent Application Ser. No. 62/898,489 filed Sep. 10, 2019 and entitled “METHODS AND APPARATUS FOR NETWORK INTERFACE FABRIC SEND/RECEIVE OPERATIONS”, and U.S. Provisional Patent Application Ser. No. 62/909,629 filed on Oct. 10, 2019 entitled “Methods and Apparatus for Fabric Interface Polling”, each of which is incorporated herein by reference in its entirety.

This application is related to co-pending U.S. patent application Ser. No. 16/566,829 filed Sep. 10, 2019 and entitled “METHODS AND APPARATUS FOR HIGH-SPEED DATA BUS CONNECTION AND FABRIC MANAGEMENT,” and U.S. patent application Ser. No. ______ filed contemporaneously herewith on Sep. 9, 2020 entitled “METHODS AND APPARATUS FOR NETWORK INTERFACE FABRIC SEND/RECEIVE OPERATIONS”, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally to the field of data buses, interconnects and networking and specifically, in one or more exemplary embodiments, to methods and apparatus for providing interconnection and data routing within fabrics comprising multiple host devices.

### 2. Description of Related Technology

In many data network topologies, a fabric of network nodes (or switches or interfaces) enables interconnected nodes to transmit and receive data via, e.g., send/receive operations. For example, a PCIe fabric is composed of point-to-point links that interconnect a set of components.

A single fabric instance (hierarchy) includes only one root port/complex (connected to the host/processor device and the host memory) and multiple endpoints (connected to peripheral devices). Thus, normally, PCIe fabric does not allow communication between multiple root devices. However, PCIe NTBs (non-transparent bridges) can virtually allow TLPs (transaction layer packets) to be translated between multiple roots. Using NTBs, roots can communicate with one another because each root views the other as a device (subject to certain limitations).

Interconnect fabric architectures such as those based in NTBs and PCIe technology use message-style communication, which entails a data movement step and a synchronization step. NTB based fabric can perform data movement (i.e., send/receive operations) between multiple hosts/processors using simple read or write processes. For example, in order for a host/processor to send a message to a remote/external host through NTB-based fabric, an NTB writes the message to the memory of that remote host (e.g. to a special “receive queue” memory region of the remote host).

The data (message) shows up in a receive queue part of remote host memory, but a synchronization step is required for the data to be received by the remote host. In other words, the remote host does not realize the message is present unless it receives a notification and/or until it actively looks for it (e.g., polls its receive queues). The receive-side synchronization step may be achieved with an interrupt process (e.g., by writing directly to an MSI-X interrupt address): however, using interrupts may contribute to high latency, especially for processes that are user-space based (as opposed to kernel-space based).

In order to attain lower latency in user-space processes, interconnect fabrics can instead use receive queue polling, where a receiving node periodically scans all the receive queues of the receiving node, in order to determine whether it has any messages. However, as interconnect fabric size expands (and a given user's or device's set of communication partners or nodes grows), the number of receive queues grows, and the individual polling of the large number of receive queues becomes a potential bottleneck. A queue pair send/receive mechanism should ideally perform within certain metrics (e.g., a very low latency, such as on the order of 1-2 microseconds or less), even as the number of queues grows. These performance requirements become untenable using prior art methods, especially as the fabric size grows large.

Accordingly, there is a need for improved methods and apparatus that enable, inter alia, efficient and effective polling of large numbers of receive queues and queue pairs.

### SUMMARY

The present disclosure satisfies the foregoing needs by providing, inler alia, methods and apparatus for improved polling efficiency in fabric operations.

In a first aspect of the disclosure, a method of polling a plurality of message data queues in a data processing system is disclosed. In one embodiment, the method includes: allocating each of the plurality of queues into one of a plurality of groups, each of the plurality of groups having at least one different attribute; assigning a polling policy to each of the plurality of groups, each of the polling policies having at least one different requirement than others of the polling policies; and performing polling of each of the plurality of groups according to its respective polling policy.

In one variant, assigning a polling policy to each of the plurality of groups, each of the polling policies having at least one different requirement than others of the polling policies, includes assigning a policy to each group which has a different periodicity or frequency of polling as compared to the policies of the other groups.

In one implementation thereof, the allocating each of the plurality of queues into one of a plurality of groups, each of the plurality of groups having at least one different attribute, includes allocating each of the plurality of queues into a group based at least on at least one of: (i) historical activity of the queue being allocated, or (ii) projected activity of the queue being allocated. For example, the allocating each of the plurality of queues into a group based at least on at least one of: (i) historical activity of the queue being allocated, or (ii) projected activity of the queue being allocated, includes allocating each of the plurality of queues into a group based at least on write activity of the queue being allocated within at least one of (i) a prescribed historical time period, or (ii) a prescribed number of prior polling iterations.

In another variant, the performing the polling of each of the plurality of groups according to its respective polling policy reduces polling relative to a linear or sequential polling scheme without use of the plurality of groups.

In a further variant, at least the assigning a polling policy to each of the plurality of groups, and the performing polling of each of the plurality of groups according to its respective polling policy, are performed iteratively based at least on one or more inputs relating to configuration of the data processing system.

In yet another variant, the allocating each of the plurality of queues, the assigning a polling policy to each of the plurality of groups, and the performing polling of each of the plurality of groups according to its respective polling policy, are performed at startup of the data processing system based on data descriptive of the data processing system configuration.

In another embodiment, the method includes: allocating each of the plurality of queues into one of a plurality of groups, each of the plurality of groups having at least one flag associated therewith; and selectively performing polling of the plurality of groups based at least on polling of the at least one flag of each group.

In one variant of this embodiment, the selectively performing polling of the plurality of groups based at least on polling of the at least one flag of each group includes: polling each queue within a group having a flag set; and not polling any queues within a group having a flag which is not set.

In one implementation thereof, the allocating each of the plurality of queues into one of a plurality of groups, each of the plurality of groups having at least one flag associated therewith, includes allocating each queue into one of the plurality of groups such that each group has an equal number of constituent queues.

In another implementation, the allocating each of the plurality of queues into one of a plurality of groups, each of the plurality of groups having at least one flag associated therewith, includes allocating each queue into one of the plurality of groups such that at least some of the plurality of groups have a number of constituent queues different than one or more others of the plurality of groups.

In a further implementation, the allocating each of the plurality of queues into one of a plurality of groups, each of the plurality of groups having at least one flag associated therewith, is based at least in part on one or more of: (i) historical activity of one or more of the queues being allocated, or (ii) projected activity of one or more of the queues being allocated.

In yet another implementation, the allocating each of the plurality of queues into one of a plurality of groups, each of the plurality of groups having at least one flag associated therewith, includes allocating the plurality of queues such that: a first flag is associated with a first number X of queues; and a second flag is associated with a second number Y of queues, with X>Y. In one configuration thereof, the selectively performing polling of the plurality of groups based at least on polling of the at least one flag of each group includes, for each group: polling the first flag of a group; and based at least on a result of the polling the first flag of the group, selectively polling or not polling the second flag of the group.

In another configuration, the selectively performing polling of the plurality of groups based at least on polling of the at least one flag of each group includes: polling the first flag of each group; and thereafter, based at least on results of the polling the first flag of each group, selectively polling or not polling the second flag of select ones of the plurality of groups.

In another aspect of the disclosure, computer readable apparatus comprising a storage medium is disclosed. In one embodiment, the medium has at least one computer program stored thereon, the at least one computer program configured to, when executed by a processing apparatus of a computerized device, cause the computerized device to efficiently poll a plurality of queues by at least: assignment of each of a plurality of queues to one of a plurality of groups, each of the plurality of groups having differing values of at least one attribute; and performance of polling of each of the plurality of groups according to a generated polling policy, the generated polling policy applicable to the plurality of groups such that each group is polled differently from the others based at least on their respective value of the at least one attribute.

In one variant, assignment of each of a plurality of queues to one of a plurality of groups, each of the plurality of groups having differing values of the at least one attribute, includes further assignment of each of a plurality of queues to one of a plurality of sub-groups within a group, the assignment of each one of a plurality of queues to one of a plurality of sub-groups based at least in part on a value of the at least one attribute associated with that one queue.

In another variant, generation of a polling policy applicable to the plurality of groups such that each group is polled differently from the others based at least on their respective at least one attribute includes dynamic generation of a backoff parameter for at least one of the plurality of groups, the dynamic generation based at least in part on a number of valid writes detected for queues within the at least one group.

In yet another variant, the assignment of each of a plurality of queues to one of a plurality of groups includes: placement of each of the plurality of queues initially within a first of the plurality of groups; and movement of a given queue of the plurality of queues to a second of the plurality of groups if either 1) data is found on the given queue, or 2) a message is sent to a second queue associated with the given queue. In one implementation thereof, the assignment of each of a plurality of queues to one of a plurality of groups further includes movement of a given queue of the plurality of queues from the second of the plurality of groups to a third of the plurality of groups if the given queue has met one or more demotion criteria.

In one configuration, the assignment of each of a plurality of queues to one of a plurality of groups further includes movement of a given queue of the plurality of queues from the third of the plurality of groups to the first of the plurality of groups if the given queue has met one or more second demotion criteria.

In another aspect, methods and apparatus for exchanging data in a networked fabric of nodes are disclosed. In one embodiment, the methods and apparatus avoid high latency and bottlenecking associated with sequential and rote reads of large numbers of queues.

In another aspect, methods and apparatus for handling messaging between a large number of endpoints without inefficiencies associated with scans of a large number of queues (including many of which would not be used or would be used rarely) are disclosed.

In another aspect, a computerized apparatus is disclosed. In one embodiment, the apparatus includes memory having one or more NT BAR spaces associated therewith, at least one digital processor apparatus, and kernel and user spaces which each map to at least portions of the NT BAR space(s). Numerous queues for transmission and reception of inter-process messaging are created, including a large number of receive queues which are efficiently polled using the above-described techniques.

In another aspect, a networked node device is disclosed.

In another aspect, computerized logic for implementing “intelligent” polling of large numbers of queues is disclosed. In one embodiment, the logic includes software or firmware configured to gather data relating to one or more operational or configuration aspects of a multi-node system, and utilize the gathered data to automatically configure one or more optimized polling processes.

In another aspect, an integrated circuit (IC) device implementing one or more of the foregoing aspects is disclosed and described. In one embodiment, the IC device is embodied as SoC (system on chip) device which supports high speed data polling operations such as those described above. In another embodiment, an ASIC (application specific IC) is used as the basis of at least portions of the device. In yet another embodiment, a chip set (i.e., multiple ICs used in coordinated fashion) is disclosed. In yet another embodiment, the device includes a multi-logic block FPGA device.

In an additional aspect of the disclosure, computer readable apparatus is described. In one embodiment, the apparatus includes a storage medium configured to store one or more computer programs, such as a message logic module of the above-mentioned network node or an end user device. In another embodiment, the apparatus includes a program memory or HDD or SDD on a computerized network controller device.

These and other aspects shall become apparent when considered in light of the disclosure provided herein.

### BRIEF DESCRIPTION OF THE DRAWINGS

FIG. 1 is a graphical illustration of one embodiment of a user message context (UMC) and a kernel message context (KMC) performing send and receive operations.

FIG. 2 is a diagram illustrating an exemplary relationship among a user message context (UMC), a kernel message context (KMC), and physical memory associated therewith, useful for describing the present disclosure.

FIG. 3 is a diagram showing amounts of memory that may be allocated by each node according to one exemplary embodiment.

FIGS. 4A-4C are diagrams that illustrate an exemplary UMC structure with a DQP at an initial state, at a pending state, and at an in-use state.

FIG. 5 is a logical flow diagram illustrating one exemplary embodiment of a generalized method of processing queue data for enhanced polling according to one aspect of the disclosure.

FIG. 6 is a state diagram of a process for separating an RX queue into different types in which queues are scanned according to different configurations FIGS. 7 and 7A illustrate various implementations of a queue-ready flag scheme, including single-tier and multi-tier approaches, respectively.

All figures and tables disclosed herein are © Copyright 2019-2020 GigaIO Networks, Inc. All rights reserved.

### DETAILED DESCRIPTION

Reference is now made to the drawings wherein like numerals refer to like parts throughout.

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment. Applications as used herein may also include so-called “containerized” applications and their execution and management environments such as VMs (virtual machines) and Docker and Kubernetes.

As used herein, the term “computer program” or “software” is meant to include any sequence or human or machine cognizable steps which perform a function. Such program may be rendered in virtually any programming language or environment including, for example, C/C++, Fortran, COBOL, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the terms “device” or “host device” include, but are not limited to, servers or server farms, set-top boxes (e.g., DSTBs), gateways, modems, personal computers (PCs), and minicomputers, whether desktop, laptop, or otherwise, as well as mobile devices such as handheld computers, PDAs, personal media devices (PMDs), tablets, “phablets”, smartphones, vehicle infotainment systems or portions thereof, distributed computing systems, VR and AR systems, gaming systems, or any other computerized device.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, GPUs (graphics processing units), microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the term “network interface” refers to any signal or data interface with a component or network including, without limitation, those of the PCIe, FireWire (e.g., FW400, FW800, etc.), USB (e.g., USB 2.0, 3.0. OTG), Ethernet (e.g., 10/100, 10/100/1000 (Gigabit Ethernet), 10-Gig-E, etc.), families.

As used herein, the term PCIe (Peripheral Component Interconnect Express) refers without limitation to the technology described in PCI-Express Base Specification, Version 1.0a (2003), Version 1.1 (Mar. 8, 2005), Version 2.0 (Dec. 20, 2006), Version 2.1 (Mar. 4, 2009), Version 3.0 (Oct. 23, 2014), Version 3.1 (Dec. 7, 2015), Version 4.0 (Oct. 5, 2017), and Version 5.0 (Jun. 5, 2018), each of the foregoing incorporated herein by reference in its entirety, and any subsequent versions thereof.

As used herein, the term “DQP” (dynamic queue pair) refers without limitation to a queue pair that is wired up on demand between two message contexts. Both RX and TX queues are accessed from user space.

As used herein, the term “KMC” (kernel message context) refers without limitation to a set of TX queue accessed from the kernel, targeting remote SRQs. There is only one KMC per node.

As used herein, the term “SRQ” (static receive queue) refers to an RX queue (part a UMC) that receives messages from a remote KMC.

As used herein, the term “UMC” (user message context) is without limitation a set of RX and TX queues that an endpoint binds to in order to perform send/receive operations. UMC includes DQPs (RX and TX queues) and SRQs (RX queues only).

As used herein, the term “server” refers without limitation to any computerized component, system or entity regardless of form which is adapted to provide data, files, applications, content, or other services to one or more other devices or entities on a computer network.

As used herein, the term “storage” refers without limitation to computer hard drives, DVR device, memory, RAID devices or arrays, SSDs, optical media (e.g., CD-ROMs, Laserdiscs, Blu-Ray, etc.), or any other devices or media capable of storing content or other information.

### Overview

In one salient aspect, the present disclosure provides mechanisms and protocols for enhanced polling of message/data queues used in communication processes within multi-node network systems (e.g., those complying with the PCIe standards), including within very large scale topologies involving e.g., hundreds or even thousands of nodes or endpoints, such as a large-scale high-performance compute or network fabric.

As referenced previously, extant designs may use queues or queue pairs that connect at the node level (e.g., one queue pair for each node pair). In large architectures, many thousands of such queues/pairs may exist, and hence traditional “linear” (sequential) or similar such polling mechanisms can present a significant load on a host CPU (and significant bottleneck for system performance overall by introducing significant levels of unwanted latency). As the number of queues grows, the latency penalty grows in an effectively exponential manner, thereby present a significant roadblock to large-scale designs and fabrics.

Hence, the improved methods and apparatus described herein address these issues by providing efficient alternatives to such traditional (linear or other) polling methods. In one such approach disclosed herein, queues are allocated (whether statically or dynamically) to groups or sets of queues based on one or more attributes associated therewith. In one variant, these attributes relate to the recent “history” of the queue; e.g., when it was last written to, and hence its priority within the system. Higher priority queue sets or groups are polled according to a different scheme or mechanism than those in other, lower priority groups, thereby providing significant economies relative to a process where all queues are checked by rote each polling increment.

In some implementations, a priori knowledge of a given queue's (or set of queues') function or operation can also be used as a basis of grouping.

In another disclosed approach, a flag is associated with each queue (or even a prescribed subset of all queues) which indicates to a reading process that the queue has been written to (i.e., since its last poll). In one variant, the queue flags comprise a single byte, consistent with the smallest allowable PCIe write size, and the queues are “tiered” such that one flag can be used to represent multiple queues. This approach provides significant economies, in that by virtue of most queues not being written to in any given polling increment, large swathes of polling which would otherwise need to be performed is obviated. A reading polling process can simply look at each flag, and if not set, ignore all constituent queues associated with that flag (e.g., 8, 16, or some other number).

### Exemplary Embodiments

Exemplary embodiments of the apparatus and methods of the present disclosure are now described in detail. While these exemplary embodiments are described in the context of PCI-based data network fabric with nodes and endpoints and UMC/KMC contexts, the general principles and advantages of the disclosure may be extended to other types of technologies, standards, networks and architectures that are configured to transact data and messages, the following therefore being merely exemplary in nature.

Message Context Physical Memory Mapping—

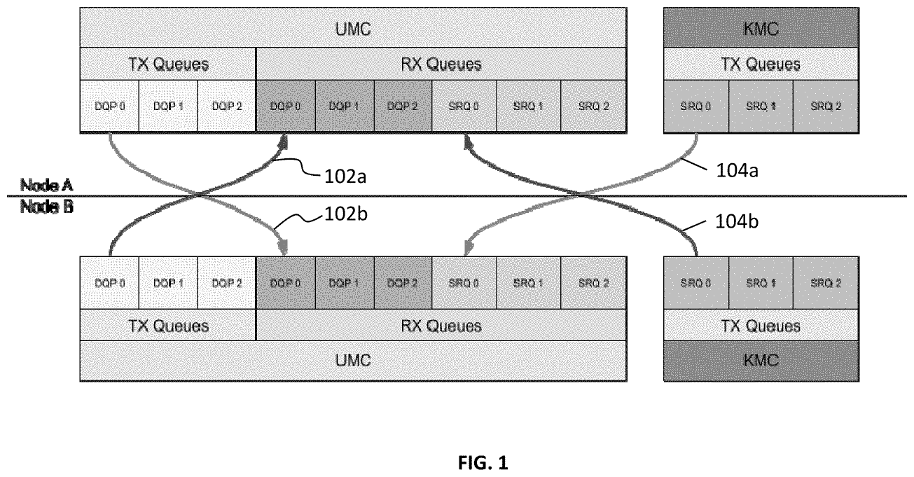

As background, FIG. 1 illustrates one exemplary architecture (developed by the Assignee hereof) involving use of a user message context (UMC) and a kernel message context (KMC) on two different nodes, with illustrative connectivities 102a, 102b and 104a, 104b shown between queues. In the context of the present disclosure, a user message context (UMC) can be thought of e.g., as a set of receive (RX) and transmission (TX) data packet queues that an endpoint (e.g., network node) binds to in order to perform send/receive operations. In exemplary embodiments, a UMC may include dynamic queue pairs (DQPs) (supplying RX and TX queues, as discussed below) and static receive queues (SRQs) (supplying RX queues only, as discussed below). In some cases, a UMC includes an array of dynamic queue pairs and static receive queues.

In one exemplary scenario, a dynamic queue pair (DQP) supplies user space-accessible transmission (TX) and receive (RX) queues. The transmission side of a DQP is wired to the receive side of another DQP on a remote node, and likewise in the other direction. See, for example, a DQP 102a and 102b. Since both the transmit and receive queues are mapped into the user space process, no transition to the kernel is needed to read or write a DQP. In one approach, the dynamic queue pair is wired up on demand between two message contexts.

A static receive queue (SRQ) supplies a user space-accessible receive queue, but not a transmission queue. In one exemplary scenario, the transmission side is provided by a shared per-node kernel message context (KMC). In the exemplary embodiment, the user must transition to the kernel to make use of the KMC. See, for example, SRQ 104a and 104b in FIG. 1. Moreover, SRQs are statically mapped to the KMC from each node in the fabric (and likewise, the KMC is statically mapped to an SRQ in each UMC in the fabric). That is, the KMC can transmit a message to every UMC in the fabric.

Since DQPs are both read and written from user space, they provide the best performance (since, for example, send/receive operations may occur without incurring data transaction costs caused by, e.g., context switching into kernel space and/or requiring additional transaction times). However, creating and connecting enough DQPs such that all endpoints can communicate would be impractical. Initially, bindings from UMCs to endpoints are one-to-one. However, DQPs connecting all endpoints may require n² DQPs, where n is the number of endpoints. In some variants, n is equal to the number of logical cores per node, times the total node count. As queue pairs and connections would increase exponentially, this would consume a large amount of memory, require large computational costs, increase latency etc. Moreover, the receiver would be required to scan a large number of queues, many of which would not be used (or would be used rarely), causing inefficiencies.

SRQs may also theoretically number in the thousands. In small-cluster applications, a linear polling approach can be used. However, in larger-scale cluster applications, quickly finding DQPs or SRQs that have new data to process, given that there may be thousands of such queues (most of them empty), presents a significant challenge.

Hence, as previously noted, there is a need for improved methods and apparatus that enable, inter alia, efficient and effective polling of large numbers of receive queues and queue pairs.

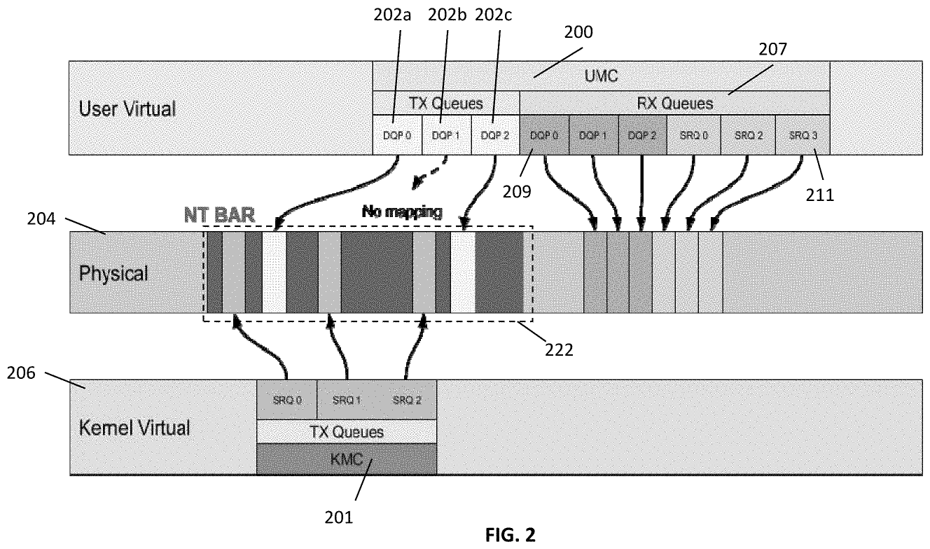

FIG. 2 illustrates a diagram showing an exemplary relationship among a UMC 200, a KMC 201, and physical memory 204 associated with the user message context (UMC) and kernel message context (KMC).

In one embodiment, RX queues are backed by physical memory on the local node. As noted supra, the physical memory may be e.g., DRAM. In some variants, the physical memory may include memory buffers (including intermediary buffers). The backing physical memory need not be contiguous, but may be implemented as such if desired.

In the illustrated embodiment, the TX side of the dynamic queue pairs (DQPs) associated with the UMC 200 may map to queues on various different nodes. Note that not all slots need to be mapped if there has not yet been a need. For example, in FIG. 2, DQP 1 (202b) is not yet mapped, while DQP 0 (202a) and DQP 2 (202c) are mapped to a portion of the backing physical memory 204.

In the illustrated embodiment, the KMC 201 is statically mapped (i.e., mapped once at setup time). In various implementations, there may be a slot in the KMC 201 for every remote UMC 200 in the fabric, although other configurations may be used consistent with the disclosure.

### Receive Queue Allocation—

Referring again to FIG. 2, the “RX Queues” portion of the UMC 200 in one exemplary embodiment is allocated and I/O mapped to the fabric by the kernel at module load time. A simple array of UMC RX queue structures 207 is allocated, whose length determines the maximum number of UMCs available in the system (an exemplary default length is given and explained below in “Message Context Sizing”). This in some scenarios allows for the assignment of queues at runtime to be simplified, since a userspace process can map all RX queues with a single invocation of mmap( ), vs. many such invocations. It may also be useful in future environments wherein memory management apparatus or logic (e.g., an input-output memory management unit (IOMMU)) is not enabled, since it would allow the kernel to allocate a large, physically contiguous chunk of memory, and simply report that chunk's base value and limit to peers (vs. needing to exchange an scatter gather list—i.e., a (potentially) long chain of memory addresses which are logically treated as a single chunk of memory—with peers).

In some variants, the region need not be physically contiguous, since it will be accessed through the MMU. This approach enables, inler alia, a more dynamic allocation scheme useful for larger clusters as a memory conservation measure.

### Message Context Sizing (RX and TX Queues)—

Referring again to FIG. 2, in one exemplary embodiment, the size of each DQP region 209 may dictated by several parameters, such as e.g., (i) the number of DQPs 209 per UMC 200, and (ii) the size of each queue.

In the exemplary embodiment, each UMC will initially be bound to a single endpoint. An endpoint may be configured to support enough DQPs 209 such that its frequent communication partners are able to use a DQP (e.g., assigned on a first-come, first-served basis). In various implementations, this number may be smaller (to various degrees) than the total number of endpoints. For example, the literature such as “Adaptive Connection Management for Scalable MPI over InfiniBand” (https://ieeexplore.ieee.org/document/1639338), incorporated herein by reference in its entirety, suggests 2 log(n) as a reasonable number, as it supports common communication patterns. As an example, a cluster with 1024 nodes, each with 16 cores is shown by Eqn. (1):

2 log(1024·16)=28 Eqn. (1)

It will be appreciated that more queues increases the cost of polling, since each queue must be polled. Additional considerations for polling are described subsequently herein in greater detail.

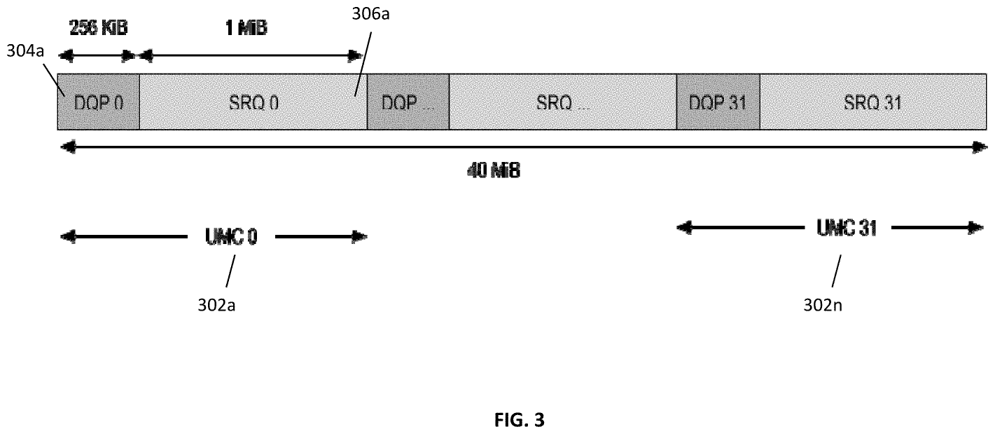

Referring now to FIG. 3, an exemplary allocation of memory to the DQPs 209 and SRQs 211 of FIG. 2 is illustrated. In one variant, this allocation will be exposed to the user process via a function such as mmap( ). Exemplary default values are 32 DQPs per UMC (e.g., UMC 0 (302a) or UMC 31 (302n) each having a DQP and SRQ) and 8 KiB per DQP. Therefore, each UMC may be allocated 256 KiB for DQPs (e.g., collectively DQP 0 (304a)). Moreover, the size of each SRQ region (e.g., SRQ 0 (306a)) is dictated by (i) the number of remote nodes and (ii) the size of each queue.

With respect to the number of remote nodes, there is generally an SRQ for all remote nodes from which this UMC may receive a message. With respect to the size of each queue, this may be exposed to the user process via the aforementioned mmap( ) function. In one implementation, each queue is 4 KiB aligned.

It will also be recognized that the cluster size may vary significantly. Loosely defined, “cluster size” in the present context can be defined as the number of different communicative nodes. In various embodiments, the initial default cluster size may be e.g., 256 nodes. Further, the default size for each SRQ may have the minimum of 4 KiB. Therefore, each UMC may devote 1 MiB to the SRQs.

Thus, given the above exemplary values, the total memory allocated and exported to the fabric by each node according to the defaults may be limited to (256 KiB+1 MiB)·32=40 MiB.

However, one with ordinary skill in the relevant art will appreciate that all the values mentioned above may be tunable, and/or dynamically assigned. In some embodiments, such parameters may be tuned or dynamically updated during runtime, or between send/receive operations. In some variants, only some of, e.g., the DQPs or SRQs, are updated between operations.

In one exemplary embodiment, a path may be provided by the KMC 201 (FIG. 2) to every remote UMC on the system (e.g., the fabric). As alluded to above, the initial default value (which again may be tuned to other values) may be set to support 256 nodes, each with 32 UMCs, with SRQs sized at 4 KiB. Therefore, the amount of memory the KMC 201 must map from the NT BAR 222 (see FIG. 2) may be represented per Eqn. (2):

4 KiB·255·32=31.875 MiB Eqn. (2)

The considerations for UMCs 200 (FIG. 2) may be somewhat different than for KMCs. Since unused TX DQP slots in the UMC 200 do not map to memory, their cost is “free” in terms of imported fabric memory. However, if all DQP slots become occupied, the mapped memory must now be visible in the NT BAR 222 (non-transparent base address register). Following the example given above, each UMC may include 32 DQP slots at 8 KiB each, and each node may include 32 UMCs. Therefore, the maximum amount of memory all UMIs must map from the NT BAR 222 may be represented per Eqn. (3)

32·32·8 KiB=8 MiB Eqn. (3)

Therefore, the maximum total amount of memory that must be reachable through the NT BAR may be approximately 40 MiB.

### Base Address Exchange—

According to some implementations disclosed herein, the kernels of nodes that wish to communicate may need to know where to find the UMC regions for their DQP peer. In one exemplary embodiment, this is accomplished by “piggybacking” on the address exchange that already takes place between e.g., kernel module used to facilitate userspace fabric operations (such as the exemplary KLPP or Kernel Libfabric PCIe Provider module of the Assignee hereof) peers. For instance, this exchange may occur the first time a node's name is resolved for the purpose of exchanging numeric addresses.

### Endpoint Binding—

As previously discussed, some exemplary embodiments of the fabric disclosed herein (e.g., in the context of Assignee's “libfabric” API) provide the concept of a “transmit context” and “receive context.” That is, an endpoint must bind to one of each in order to send and receive messages. These contexts may be shared between endpoints (via, e.g., fi_stx_context or fi_srx_context signals), or be exclusive to one endpoint (via, e.g., fi_tx_context or fi_rx_context signals). It will be noted that the sharing mode of the transmit side and the receive side need not match. As an example, an endpoint may bind to a shared transmit context and an exclusive receive context.

Similarly, in exemplary embodiments, a UMC 200 may be bound to an endpoint, and offer a similar shared/exclusive model, in which a UMC may be bound to one or many endpoints.

However, the functionality of DQPs may require symmetric binding (as opposed to the aforementioned shared/exclusive binding). This is because part of the queue pair is used for syncing metadata between peers. As such, exemplary embodiments require exactly one RX queue and one TX queue on each side, an invariant that asymmetric binding breaks.

Initially, every endpoint may be bound to a single UMC, even if an exemplary fabric implementation requests shared contexts. Note that, since UMCs and endpoints may be bound one-to-one initially as noted above, this effectively limits the number of endpoints per node to the number of UMCs that have been allocated.

### Dynamic Queue Pairs (DQPs) and Assignment

In exemplary embodiments of the disclosed architecture, all DQPs are initially unassigned. Although the TX and RX regions are mapped into the user process, the RX queues are empty (i.e., initialize with empty queues), and the TX queues have no backing pages (e.g., from backing memory 204 of FIG. 2).

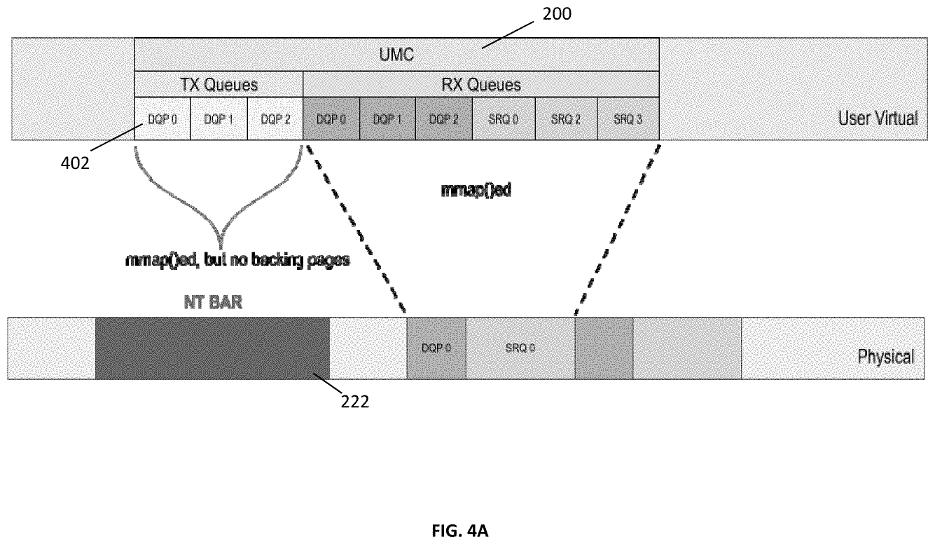

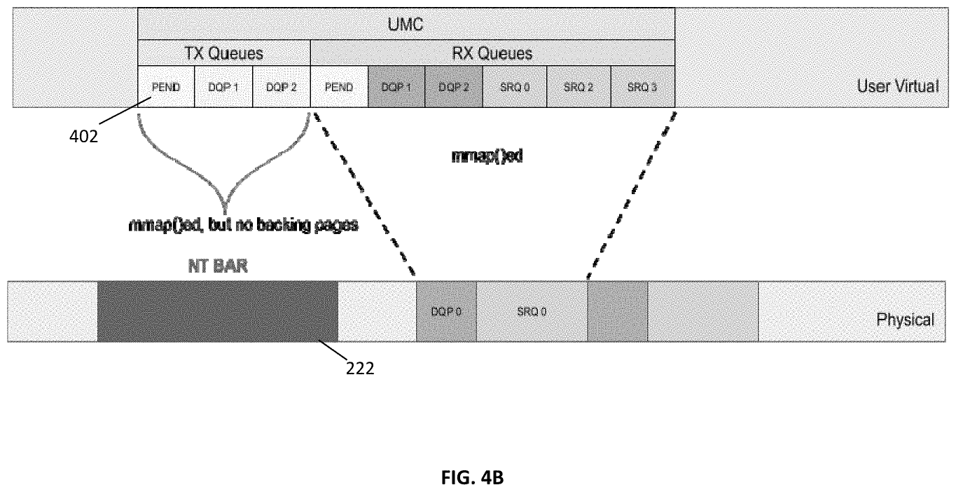

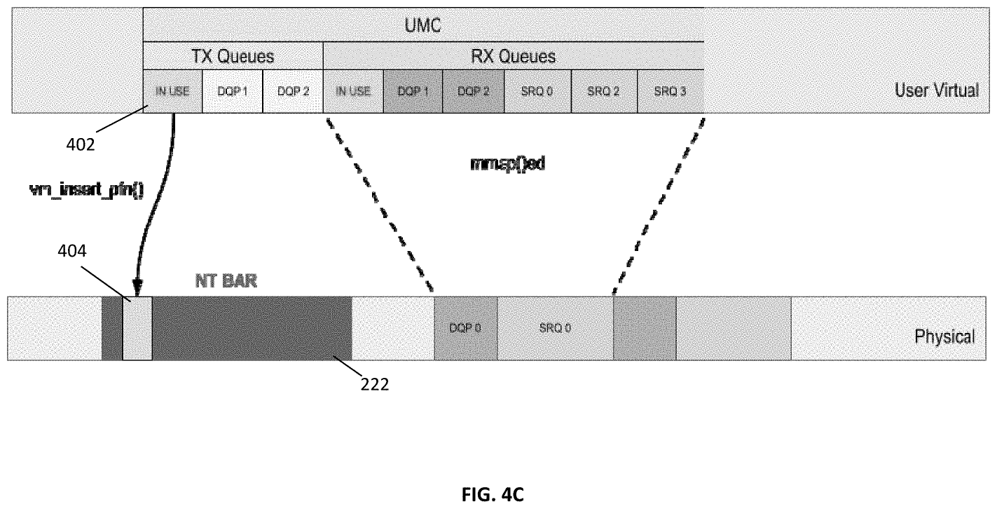

FIG. 4A illustrates an exemplary UMC structure with 3 DQPs per UMC in their initial states. While the SRQ region is shown, the details are not shown.

In one exemplary embodiment, the mechanism for “wiring up” a DQP 207 includes a transmission of a signal or command by the kernel (e.g., kernel 206), such as a DQP_REQUEST command. The possible replies may include DQP_GRANTED and DQP_UNAVAIL.

A command such as DQP_REQUEST may be issued in certain scenarios. For example: (i) an endpoint sends a message to a remote endpoint for which its bound UMC does not have a DQP assigned (i.e., it must use the KMC to send this message); (ii) the endpoint's bound UMC has a free DQP slot; and (iii) the remote UMC has not returned a DQP_UNAVAIL within an UNAVAIL_TTL.

More specifically, when a UMC must refuse a DQP_REQUEST because it has no free DQP slots, it will return a TTL (time-to-live signal, e.g., a “cooldown” or backoff timer) to the sender reporting to indicate when the sender may try again. This is to prevent a flood of repeated DQP_REQUESTs which cannot be satisfied.

In the exemplary embodiment, the DQP_REQUEST is issued automatically by the kernel 206 when a user makes use of the KMC 201. The kernel will transmit the user's message via the KMC, and additionally send a DQP_REQUEST message to the remote system's kernel receive queue (such as an ntb_transport queue). In another embodiment, DQPs may be assigned only when explicitly requested (i.e., not automatically).

When the kernel sends a DQP_REQUEST command, it causes the next available slot in both the UMC to be marked as “pending” and reports that slot number in the DQP_REQUEST. As shown in FIGS. 4A and 4B, DQP 0 402 becomes marked as “pending”. The slot remains in this state until a reply is received.

In some exemplary embodiments, a node that receives a DQP_REQUEST must check if the local UMC has an available slot. If so, the UMC assigns the slot and replies with DQP_GRANTED and the assigned slot index. If there is no slot, the UMC replies with DQP_UNAVAIL and UNAVAIL_TTL as discussed above.

Both nodes may then map the TX side into the NT BAR 222, and mark the RX side as in use. As shown in FIG. 4C, DQP 0 (402) is now marked “IN USE” in the TX queue and the RX queue. A corresponding portion 404 of the NT BAR 222 may similarly be marked as in use.

In the exemplary embodiment, the users are informed of the new DQP mapping by an event provided via the kernel-to-user queue. The address of the newly mapped DQP is provided by the kernel, allowing the user to identify the source of messages in the RX queue. If the UMC 200 is shared by multiple endpoints, all associated addresses will be reported, with an index assigned to each. This index is used as a source identifier in messages.

### Improved Polling Efficiency—

As discussed supra, SRQs may also theoretically number in the thousands in larger-scale cluster applications, and quickly finding DQPs or SRQs that have new data to process, given that there may be thousands of such queues (with most of them empty in most operating scenarios), presents a significant challenge.

In polling scenarios which call for (or are optimized using) polling with no interrupts, a given user may need to scan thousands of RX queues to find newly received data. This scan process needs to be accomplished with a minimum of overhead to avoid becoming a bottleneck.

Ultimately, the entire queue pair send/receive mechanism must perform at competitive levels; e.g., on the order of 1-2 μs. Within such constraints, other requirements can be further identified for a given application or configuration. These additional requirements may include.

1. Support polling up to a prescribed number of RX queues with scalability. As cluster sizes increase with time, it is also desirable to have polling mechanisms which can support such greater sizes in a scalable fashion. Some scenarios may be adequately serviced using 256 RX queues, while others may require more (e.g., 1024 or beyond). Hence, a design that can scale up further beyond these levels is certainly desirable.

2. Overhead vs. “baseline.” It is also useful to identify an overhead criteria that can be used to assess performance of the polling mechanism. For instance, an overhead target of e.g., <5% may be specified as a performance metric. It is noted that such targets may also be specified on various bases, such as (i) on an overall average of all queues, or (ii) as a maximum ceiling for any queue. Moreover, different queues (or groups of queues) may be allocated different target values, depending on their particular configuration and constraints attached.

With the foregoing as a backdrop, exemplary embodiments of enhanced polling schemes are now described in detail. It will be appreciated that while described herein as based on a model wherein transactions are read/written from userspace, with kernel involvement only for setup, as discussed in U.S. patent application Ser. No. ______ filed contemporaneously herewith on Sep. 9, 2020 entitled “METHODS AND APPARATUS FOR NETWORK INTERFACE FABRIC SEND/RECEIVE OPERATIONS” [GIGA.016A], the polling methods and apparatus described herein may also be used with other architectures and is not limited to the foregoing exemplary UMC/KMC-based architecture.

### Polling Groups—

Generally speaking, the inventor hereof has observed that in many scenarios, a given process communicates frequently with a comparatively small number of peers, and less frequently with a larger number of peers, and perhaps never with others. It is therefore important to regularly poll the frequent partners to keep latency low. The infrequent peers may be more tolerant of higher latency.

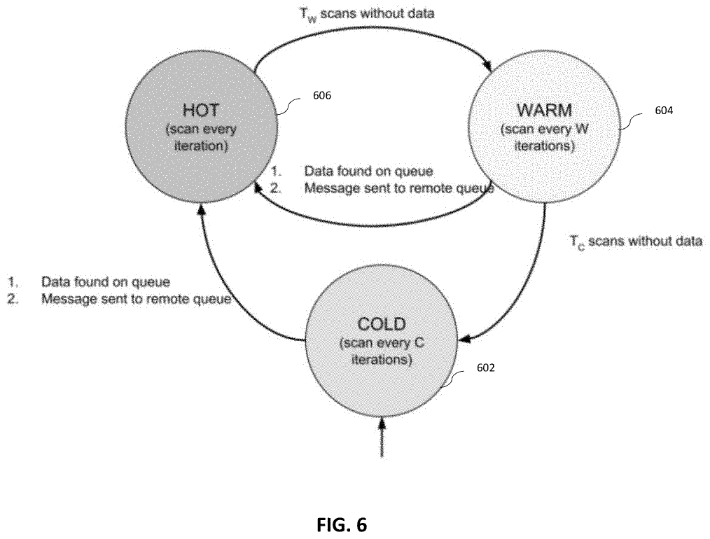

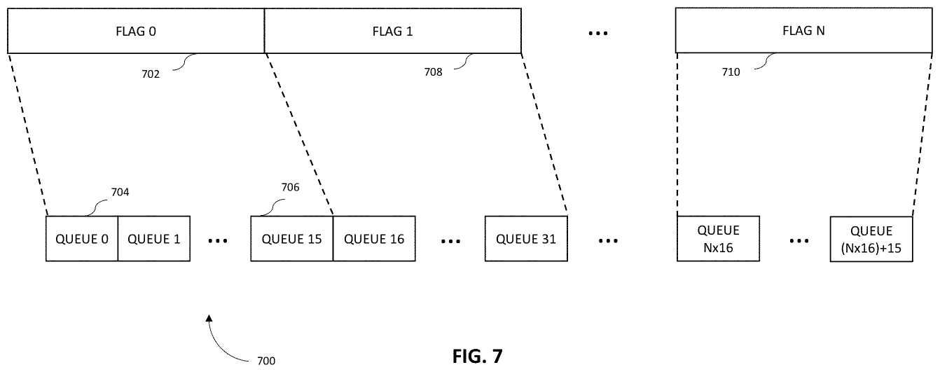

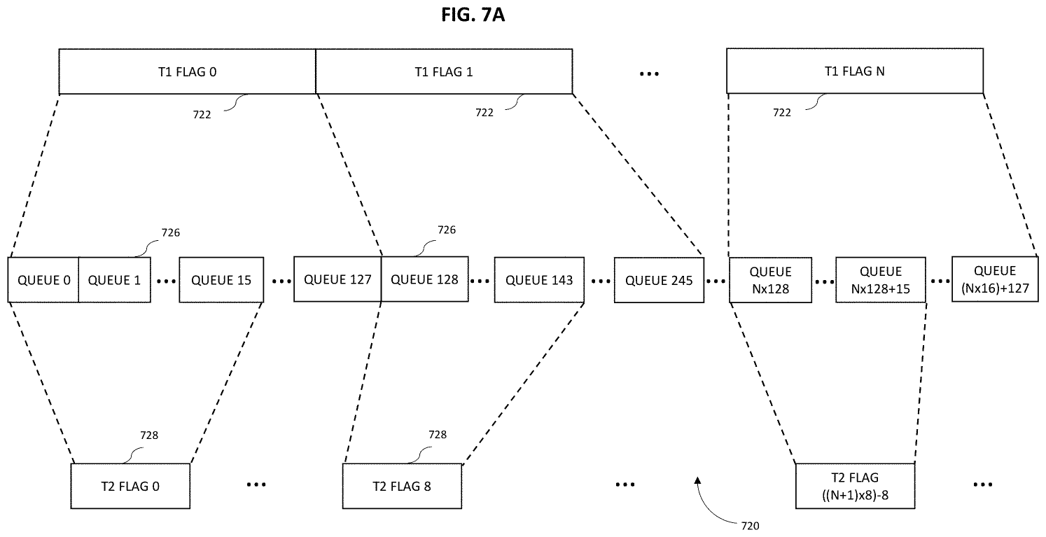

One way to accomplish the above polling functionality is to separate RX queues into multiple groups, and poll the queue groups according to their priority (or some other scheme which relates to priority). For example (described below in greater detail with respect to FIG. 6), queues that have recently received data (or which correspond to an endpoint that has recently been sent data) are in one embodiment considered to be part of a “hot” group, and are polled every iteration.

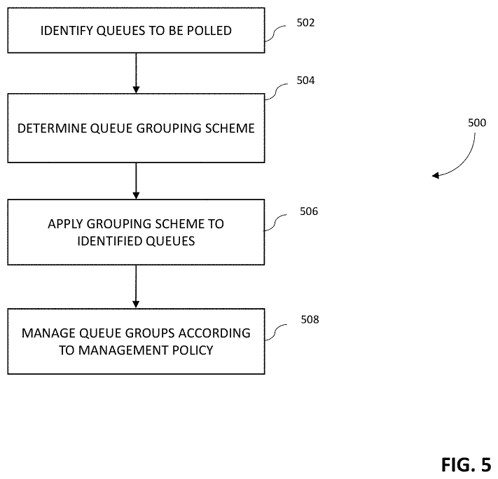

FIG. 5 is a logical flow diagram illustrating one exemplary embodiment of a generalized method of polling queue data using grouping. Per step 502 of the method 500, queues to be polled are identified. This identification may be accomplished by virtue of existing categorizations or structures of the queues (e.g., all RX queues associated with a given UMC), based on assigned functionality (e.g., only those RX queues within a prescribed “primary” set of queues to be used by an endpoint), or independent of such existing categorizations or functions.

Per step 504, the queue grouping scheme is determined. In this context, the queue grouping scheme refers to any logical or functional construct or criterion used to group the queues. For instance, as shown in the example of FIG. 6 discussed below, one such construct is to use the activity level of a queue as a determinant of how that queue is further managed. Other such constructs may include for instance ones based on QoS (quality of service) policy, queue location or address, or queues associated functionally with certain endpoints that have higher or lower activity or load levels than others.

Per step 506, the grouping scheme determined from step 504 is applied to the identified queues being managed from step 502. For example, in one implementation, polling logic operative to run on a CPU or other such device is configured to identify the queues associated with each group, and ultimately apply the grouping scheme and associated management policy based on e.g., activity or other data to be obtained by that logic (step 508).

FIG. 6 shows a state diagram of one implementation of the generalized method of FIG. 5. In this implementation, the RX queues are separated into three groups or sets: hot, warm, and cold. The “hot” set is scanned every iteration, the “warm” set every W iterations (W>1), and the “cold” set every C iterations (C>W).

In terms of polling policy/logic, in this embodiment, all queues are initially placed (logically) in the cold set 602. A queue is moved to the hot set 606 if either 1) data is found on the RX queue, or 2) a message is sent targeting the remote queue (in this case, a reply is expected soon, hence the queue is promoted to the hot set 606).

A queue is moved from the hot set 606 to the warm set 604 if it has met one or more demotion criteria (e.g., has been scanned Tw times without having data). The queue is returned (promoted) to the hot set 606 if data is found again, or if a message is sent to that remote queue.

A queue is moved from the warm set 604 to the cold set 602 if it meets one or more other demotion criteria (e.g., has been scanned Tc times without having data). The queue is returned to the hot set 606 if data is found again or if a message is sent to that remote queue.

As such, in the model of FIG. 6, queues which have received data, but not recently, are considered to be within a “warm” group, and are polled at a different frequency or on a different basis, such as every N iterations (e.g., N=8). Queues that have rarely/never seen data (e.g., either in their entire history, or within a prescribed period of time or iterations) are considered to be within a “cold” group, and are polled at another frequency or different basis, such as every M=64 iterations.

The exemplary method of FIGS. 5 and 6 include various variables that may affect performance and for which tuning may more effectively implement the method. For example, in the exemplary context of FIG. 6, as the total number of queues grows, C (the frequency at which the “cold” set is scanned) generally must increase too, in order to maintain performance of the “hot” set. Otherwise, the overhead of scanning the large cold set may dominate. But increasing C means a queue in the “cold” set will experience increased latency. Nevertheless, the polling set method includes several advantages, including that no additional data needs to be sent for each message, and if the thresholds are tuned well, the poll performance ostensibly scales well (with the number of queues).

In one approach, the initial values of the tunable parameters are in effect trial values or “educated guesses,” with further refinement based on review of results and iteration. This process may be conducted manually, or automatically, such as by an algorithm which selects the initial values (based on e.g., one or more inputs such as cluster size or job size), and then evaluates the results according to a programmed test regime to rapidly converge on an optimized value for each parameter). This process may also be re-run to converge on new optimal values when conditions have changed. Table 1 below illustrates exemplary values for W, C, Tw, and T variables.

TABLE 1

| | |
|---|---|
| W | 512 |
| C | 16384 |
| T_{W} | 16384 |
| T_{C} | 16384 |

It will be appreciated that various modifications to the above polling group scheme may be utilized consistent with the present disclosure. For example, in one alternate embodiment, the scheme is extended beyond the 3 groups listed, into an arbitrary or otherwise determinate number of groups where beneficial. For instance, in one variant, five (5) groups are utilized, with an exponentially increasing polling frequency based on activity. In another variant, one or more of the three groups discussed above include two or more sub-groups which are treated heterogeneously with respect to one another (and the other groups) in terms of polling.

Moreover, different polling sets or groups may be cooperative, and/or “nested” with others.

It will further be appreciated that the polling group scheme may be dynamically altered, based on e.g., one or more inputs relating to data transaction activity, or other apriori knowledge regarding use of those queues (such as where certain queues are designated as “high use”, or certain queues are designated for use only in very limited circumstances).

In one variant, the values of the various parameters (e.g., C, W) are dynamically determined based on polling “success”—in this context, loosely defined as how many “hits” the reading process gets in a prior period or number of iterations for a given group/set. For example, in one variant, based on initial values of C and W, if the “cold” set only hits (i.e., a write is detected upon polling of that set) at a low frequency and does not increase, the algorithm may backoff the value of C to a new value, and then re-evaluate for a period of time/iterations to see if the number of hits is increased (thereby indicating that some of the queues are being prejudiced by unduly long wait times for polling). Similarly, W can be adjusted based on statistics for the warm set, based on the statistics of the cold (or hot) sets, or both.

### Test Environment and Results—

Testing of the foregoing polling set mechanisms is now described for purposes of illustration of the improvements provided. The test hardware utilized a pair of Intel i7 Kaby Lake systems with a PLX card and evaluation switch. The test code is osu_latency v5.6.1, with parameters “-m 0:256 -x 20000 -i 30000”. As part of this testing, the queues were laid out in an array, and each queue is 8 KiB total size for purposes of evaluation.

Firstly, the aforementioned baseline results were generated by linearly scanning each RX queue in the array of queues one at a time, looking for new data. Data was (intentionally) only ever received on one of these queues, in order to maximize scanning overhead (most of the queues that are scanned have no data), so as to identify worst-case performance.

Appendix I hereto shows a table of the number of queues the receiver scans according to one exemplary embodiment of the disclosure, wherein the term “QC” refers to the number of queues the receiver must scan. “QN” refers to the index of the active queue (the queue that receives data; all other queues are always empty). The numbered columns indicate payload size in bytes, with the values indicating latency in μs.

As Appendix I illustrates, the overhead of scanning 32 queues (an example target number of DQPs) is negligible. However, at 128 queues scanned, there is notable overhead, on the order of 40% when QN=0.

As shown in Appendix II hereto, QN=V indicates that the QN (queue index number) value was changed throughout the course of the test. This was accomplished by incrementing the queue number every 4096 messages sent. Each time the queue number changed, a new queue from the “cold” group or set was rotated into operation. Therefore, this test mode factors in additional latency that queues in the cold set experience where the frequency of scan is modified.

To briefly illustrate one effect of changing parameters under the polling group model, consider the results in Appendix III, where the value of C (cold set interval) has been changed from 16384 to 131072. With fewer scans of the large cold set needed, performance is significantly improved when QN is fixed. However, it can degrade performance for some sizes when QN is variable. Hence, in one embodiment, the variables mentioned above are considered as an ensemble (as opposed to each individually in isolation) in order to identify/account for any interdependencies of the variables.

The foregoing illustrates that the polling group/set technique is comparatively more complicated in terms of proper tuning than other methods. There are more thresholds that require tuning to obtain optimal performance. Queues in the cold set also can suffer from higher latency. Moreover, the latency seen by a given queue is not easily predictable, as it depends on which set or group that particular is in.

Advantageously, however, no additional data needs to be sent for each message (as in other techniques described herein, such as ready queue flags), and if the above thresholds are tuned well, the performance scales well (i.e., similar performance levels are achieved with larger numbers of queues/clusters). Moreover, queues in the exemplary “hot” set (see FIG. 6) may experience reduced latency (e.g., as compared to the queue flag method described infra).

### Queue Ready Flags—

In another embodiment of the disclosure, each RX queue has a flag in a separate “queue flags” region of memory. In one variant, each flag is associated with one RX queue. The flags are configured to utilize a single byte (the minimum size of a PCIe write). When a sender writes to a remote queue, it also sets the corresponding flag in the queue flags region, the flag indicating to any subsequent scanning process that the queue has active data. The use of the queue flags region approach is attractive because, inter alia, the region can be scanned linearly much more quickly than the queues themselves. This is because the flags are tightly packed (e.g., in one embodiment, contiguous in virtual address space, which in some cases may also include being contiguous in physical memory). This packing allows vector instructions and favorable memory prefetching by the CPU to accelerate operations as compared to using a non-packed or non-structured approach (e.g., in scanning the queues themselves, a non-structured or even randomized approach is used, due to the fact that scanning the queue requires reading the its value at the current consumer index—consumer indexes all start at 0, but over the course of receiving many messages, the values will diverge).

As further illustration of the foregoing, an initial test performed by the Assignee hereof on an Intel i7 Kaby Lake processor architecture showed that for an exemplary array of 10,000 elements in which only the last flag is set (e.g., flag with index 9999 set, and flags with index 0-9998 not set), the scan completes in 500-600 ns on average.

### Tiered Queue Ready Flags—

One variant of the queue flags scheme described supra is one in which the flags are split into multiple tiers. FIG. 7 illustrates one implementation 700 of this variant. As shown, a first flag 702 is allocated a given number of queues 704, and the second flag 708 a second (like) number of queues, and the Nth flag also a like number of queues 704.

As one example of the foregoing, suppose there are 1024 queues to scan. There are 64 single byte top-level queue flags (based on 16 queues per queue flag). Therefore, queues 0-15 share flag 0, 16-31 share flag 1, 32-47 share flag 3, and so on. If any of the first 16 queues (0-15) receives data, flag 0 is set. Upon seeing flag 0 set, the receiver scans all 16 of the first queues. Therefore, the use of a common flag for multiple queues acts as a “hint” for the scanning process; if the flag is not set, it is known that no data has been written to any of the associated queues. Conversely, if the flag is set, the scanning process knows that at least one queue has been written to (and perhaps more), and hence all queues associated with that flag must be scanned.

Notably, in another variant (see FIG. 7A), the foregoing multi-queue per flag approach can be extended with another tier of flags, such as in cases where the number of queues is even larger. As shown in the implementation 720 of FIG. 7A, a plurality of top-level (tier 1 or T) flags 722 are each allocated to a prescribed number of queues 726. Additionally, the prescribed numbers of queues are sub-grouped under second-level or tier 2 (T2) flags 728 as shown, in this case using an equal divisional scheme (i.e., each T1 flag covers the same number of queues as other T1 flags, and each T2 flag covers the same number of queues as other T2 flags).

As one example of the foregoing, consider that there are 8192 queues to scan (N=63). There are 64 top-level queue flags 722, assigning each top-level flag 128 queues 726. For each top-level queue flag, there are 8 second-level queue flags 728, assigning 16 queues to each second-level flag. After a sender writes its message, it sets the second tier flag (T2) 728, and then the first tier flag T1 that correspond to its queue number. The receiver scans first tier flags 722. When it finds one set, it scans the corresponding second tier flags 728, and finally the associated queues themselves.

Advantageously, initial testing performed by the Assignee hereon on an Intel i7 Kaby Lake processor architecture (discussed in greater detail below) showed that the overhead of setting 2 flags as part of a write operation adds only approximately 100 ns of latency. By comparison, per the baseline results included in Appendix I hereto, scanning only 128 queues with the naive implementation contributes several hundred ns.

Moreover, this queue ready flag approach provides roughly equal (and predictable) latency to all queues. A queue that is receiving data for the first time does not pay any “warm up cost”. It has also been shown to readily scale up to quite a large number of queues.

However, it will also be noted that the ready flag technique requires an extra byte of information to be sent with every message (as compared to no use of ready flags). This “cost” is paid even if only one queue is ever used, since a flag will be triggered if any of the associated queues is utilized for a write operation. A cost is also paid on the RX side, where many queues may be scanned (and all queue flags must be scanned), even if only one queue is ever active. This means there is a fixed added latency, which will be greater on slower CPUs. However, it is noted that queue flags would likely outperform naive queue scanning for any CPU with even a relatively small number of queues (e.g., 256).

It will be appreciated by those of ordinary skill given the present disclosure that additional tiers may be added to the scheme above (e.g., for a three-tiered approach), although as additional tiers are added, the latency is expected to increase linearly

Moreover, it is contemplated that the configuration and number of tiers and the ratio of queues-per flag (per tier) may be adjusted to optimize the performance of the system as a whole, such as from a latency perspective. For example, for extremely large clusters with tens of thousands of queues, one ratio/tier structure may be optimal, whereas for a smaller cluster with much fewer queues, a different ratio/tier structure may be more optimal.

It will also be recognized that aspects of the present disclosure are generally predicated on the fact that interrupts are too slow for many operating scenarios (as discussed previously herein). However, certain operations may benefit from the use of interrupts, especially if they can be tuned to perform faster. As but one example, writing an entry indicating which RX queue has data could be performed directly from an ISR (interrupt service routine), eliminating much of the receive side latency. This type of interrupt-based approach can be used in concert with the various polling techniques described herein (including selectively and dynamically, such as based on one or more inputs) to further optimize performance under various operational configurations or scenarios.

### Test Environment and Results—

Testing of the foregoing queue-ready polling mechanisms is now described for purposes of illustration of the improvements provided. As with the polling groups described above, the test hardware utilized a pair of Intel i7 Kaby Lake systems with a PLX card and evaluation switch. The test code is osu_latency v5.6.1, with parameters “-m 0:256 -x 20000 -i 30000”. As part of this testing, the queues were laid out in an array, and each queue is 8 KiB total size for purposes of evaluation. Baseline results were again generated by linearly scanning each RX queue in the array of queues one at a time, looking for new data. Data was (intentionally) only ever received on one of these queues, in order to maximize scanning overhead (most of the queues that are scanned have no data), so as to identify worst-case performance.

As shown in Appendix I hereto, “QC” refers to the number of queues the receiver must scan. “QN” refers to the index of the active queue (the queue that receives data; all other queues are always empty). The numbered columns indicate payload size in bytes, with the values indicating latency in μs.

In the exemplary implementation of the queue ready flag scheme (described above), an array of 8 bits/1 byte flags were created and IO mapped, one for each RX queue. When a transmitter sends a message to a queue, it also sets the remote queue flag to “1”. The RX side scans the queue flags, searching for non-zero values. When a non-zero value is found, the corresponding queue is checked for messages.

As discussed above, this method provides good performance because the receiver scans a tightly packed array of flags, which the CPU can perform relatively efficiently (with vector instructions and CPU prefetching). This method is also, however, fairly sensitive to compiler optimizations (one generally must use -O3 for good results), as well as the exact method used in the code itself. The following illustrates exemplary RX scanning code used in this testing:

int next_ready_q = 0;
int ready_qs[KLPP_N_QPS];
uint64_t *fbuf = (uint64_t*) lpp_epp−>local_q_flags−>flag;
for (int i = 0; i < KLPP_N_QPS / 8; i++, fbuf++) {

if (_{——}builtin_expect(*fbuf != 0, 0)) {
uint8_t *b = (uint8_t*)fbuf;
for (int j = 0; j < 8; j++, b++) {

if (*b != 0) {

qn = i * 8 + j;
ready_qs[next_ready_q] = qn;
next_ready_q++;

}

}
*fbuf = 0;

}

}
for (int i = 0; i < next_ready_q; i++) {

process_q(lpp_epp, ready_qs[i]);

}
©Copyright 2019-2020 GigaIO Networks, Inc. All rights reserved.

Appendix IV shows the results arising from the test environment based on the RX scanning code shown above. In reading down the first column of table of Appendix IV, where the values are not increasing moving down the column, it is indicative that the scheme scales well as QC grows for this payload size. So, e.g., looking at Appendix IV, for payload size 0, performance is equal for QC=4096 and QC=128. In general, the results are within a few hundred ns in the various columns as QC grows, which indicates favorable scaling properties.

As previously discussed, in one variation of this ready-flag technique, several queues can share the same flag. For example, queues 0-7 all share flag 0 (see FIG. 7). If a transmitter targets any of those first 8 queues, it sets flag 0. If a receiver finds flag 0 set, it scans queues 0-7 (even though it may be that only one of those queues has data). Using this “tiered” approach increases the scalability of this technique. See Appendix V for results of this testing. In this table, it can be seen that at payload size 0, the latency is actually slightly lower for QC=16 k queues than for QC=128 with tiered flags. The larger payloads with large queue count are similarly within a few hundred ns of the QC=128 values, again indicating good scaling properties.

### Additional Considerations

The mechanisms and architectures described herein are accordingly equally applicable, with similar advantages, whether the components used to build the fabric supports the PCIe protocol, the Gen-Z protocol, both, or another protocol.

Moreover, it will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

### Appendix I

| QC | QN | 0 | 1 | 2 | 4 | 8 | 16 | 32 | 64 | 128 | 256 |
|---|---|---|---|---|---|---|---|---|---|---|---|
| 1 | 0 | 1.18 | 1.24 | 1.23 | 1.24 | 1.25 | 1.29 | 1.42 | 1.65 | 1.75 | 1.98 |
| 32 | 0 | 1.22 | 1.24 | 1.24 | 1.24 | 1.24 | 1.24 | 1.28 | 1.38 | 1.66 | 2.12 |
| 32 | 31 | 1.15 | 1.18 | 1.18 | 1.18 | 1.19 | 1.18 | 1.26 | 1.31 | 1.59 | 1.98 |
| 64 | 0 | 1.40 | 1.43 | 1.42 | 1.40 | 1.41 | 1.42 | 1.52 | 1.58 | 1.83 | 2.23 |
| 64 | 63 | 1.19 | 1.26 | 1.25 | 1.25 | 1.25 | 1.25 | 1.31 | 1.40 | 1.62 | 2.06 |
| 128 | 0 | 1.61 | 1.66 | 1.70 | 1.67 | 1.62 | 1.60 | 1.75 | 1.86 | 2.04 | 2.54 |
| 128 | 127 | 1.24 | 1.37 | 1.39 | 1.38 | 1.37 | 1.36 | 1.43 | 1.49 | 1.74 | 2.19 |

### Appendix II

| QC | QN | 0 | 1 | 2 | 4 | 8 | 16 | 32 | 64 | 128 | 256 |
|---|---|---|---|---|---|---|---|---|---|---|---|
| 128 | 0 | 1.23 | 1.31 | 1.31 | 1.31 | 1.31 | 1.31 | 1.35 | 1.56 | 1.91 | 2.13 |
| 128 | V | 1.36 | 1.41 | 1.42 | 1.43 | 1.41 | 1.39 | 1.43 | 1.67 | 2.02 | 2.27 |
| 256 | 0 | 1.23 | 1.33 | 1.33 | 1.32 | 1.36 | 1.32 | 1.35 | 1.55 | 1.90 | 2.15 |
| 256 | V | 1.36 | 1.43 | 1.42 | 1.42 | 1.45 | 1.44 | 1.51 | 1.70 | 2.06 | 2.29 |
| 512 | 0 | 1.23 | 1.32 | 1.34 | 1.31 | 1.32 | 1.35 | 1.35 | 1.57 | 1.90 | 2.16 |
| 512 | V | 1.37 | 1.41 | 1.44 | 1.44 | 1.44 | 1.44 | 1.50 | 1.72 | 2.07 | 2.29 |
| 1024 | 0 | 1.26 | 1.35 | 1.34 | 1.37 | 1.35 | 1.34 | 1.38 | 1.58 | 1.93 | 2.18 |
| 1024 | V | 1.37 | 1.42 | 1.43 | 1.43 | 1.43 | 1.43 | 1.48 | 1.71 | 2.07 | 2.30 |
| 2048 | 0 | 1.32 | 1.41 | 1.44 | 1.44 | 1.44 | 1.45 | 1.53 | 1.64 | 2.01 | 2.44 |
| 2048 | V | 1.40 | 1.60 | 1.57 | 1.57 | 1.61 | 1.62 | 1.66 | 1.90 | 2.14 | 2.35 |
| 4096 | 0 | 1.39 | 1.50 | 1.51 | 1.50 | 1.48 | 1.50 | 1.53 | 1.75 | 2.12 | 2.32 |
| 4096 | V | 1.56 | 1.65 | 1.66 | 1.64 | 1.67 | 1.67 | 1.71 | 1.97 | 2.20 | 2.45 |
| 8192 | 0 | 1.63 | 1.66 | 1.73 | 1.72 | 1.74 | 1.74 | 1.71 | 1.95 | 2.36 | 2.56 |
| 8192 | V | 1.72 | 1.83 | 1.82 | 1.87 | 1.86 | 1.87 | 1.92 | 2.10 | 2.41 | 2.68 |

### Appendix III

| QC | QN | 0 | 1 | 2 | 4 | 8 | 16 | 32 | 64 | 128 | 256 |
|---|---|---|---|---|---|---|---|---|---|---|---|
| 8192 | 0 | 1.28 | 1.37 | 1.38 | 1.39 | 1.40 | 1.36 | 1.39 | 1.60 | 1.95 | 2.20 |
| 8192 | V | 1.72 | 1.74 | 1.77 | 1.74 | 1.76 | 1.76 | 1.78 | 1.90 | 3.11 | 3.40 |

### Appendix IV

| QC | QN | 0 | 1 | 2 | 4 | 8 | 16 | 32 | 64 | 128 | 256 |
|---|---|---|---|---|---|---|---|---|---|---|---|
| 128 | 0 | 1.31 | 1.35 | 1.3 [symbol] | 1.35 | 1.3 [symbol] | 1.39 | 1.3 [symbol] | 1.50 | 1.95 | 2.1 [symbol] |
| 128 | 127 | 1.30 | 1.32 | 1.32 | 1.32 | 1.33 | 1.32 | 1.3 [symbol] | 1.62 | 1.88 | 2.12 |
| 256 | 0 | 1.21 | 1.30 | 1.30 | 1.30 | 1.29 | 1.29 | 1.35 | 1.55 | 1.79 | 2.41 |
| 256 | 255 | 1.25 | 1.33 | 1.35 | 1.33 | 1.33 | 1.32 | 1.3 [symbol] | 1.50 | 1.79 | 2.25 |
| 512 | 0 | 1.29 | 1.37 | 1.36 | 1.3 [symbol] | 1.37 | 1.3 [symbol] | 1.41 | 1.53 | 1.79 | 2.21 |
| 512 | 511 | 1.28 | 1.36 | 1.35 | 1.35 | 1.35 | 1.36 | 1.45 | 1.51 | 1.63 | 2.20 |
| 1024 | 0 | 1.30 | 1.40 | 1.40 | 1.41 | 1.41 | 1.42 | 1.46 | 1.57 | 1.77 | 2.26 |
| 1024 | 1023 | 1.30 | 1.32 | 1.34 | 1.32 | 1.32 | 1.32 | 1.35 | 1.44 | 1.75 | 2.22 |
| 2048 | 0 | 1.22 | 1.30 | 1.30 | 1.30 | 1.30 | 1.29 | 1.45 | 1.62 | 1.68 | 2.31 |
| 2048 | 2047 | 1.25 | 1.32 | 1.32 | 1.32 | 1.32 | 1.33 | 1.41 | 1.51 | 1.73 | 2.1 [symbol] |
| 4096 | 0 | 1.31 | 1.31 | 1.30 | 1.30 | 1.31 | 1.31 | 1.33 | 1.58 | 2.03 | 2.50 |
| 4096 | 4095 | 1.30 | 1.37 | 1.36 | 1.38 | 1.37 | 1.37 | 1.43 | 1.50 | 1.74 | 2.23 |
| 8192 | 0 | 1.66 | 1.65 | 1. [symbol] 4 | 1.65 | 1.65 | 1.65 | 1.67 | 1.67 | 1.76 | 2.69 |
| 8192 | 8191 | 1.35 | 1.43 | 1.43 | 1.43 | 1.43 | 1.45 | 1.51 | 1.57 | 1.85 | 2.29 |

[symbol]

indicates data missing or illegible when filed

### Appendix V

| QC | QN | 0 | 1 | 2 | 4 | 8 | 16 | 32 | 64 | 128 | 256 |
|---|---|---|---|---|---|---|---|---|---|---|---|
| 8192 | 0 | 1.34 | 1.38 | 1.37 | 1.37 | 1.39 | 1.37 | 1.41 | 1.58 | 1. [symbol] 2 | 2.29 |
| 8192 | 8191 | 1.27 | 1.36 | 1.35 | 1.35 | 1.35 | 1.35 | 1.41 | 1.56 | 1.70 | 2.22 |
| 16384 | 0 | 1.28 | 1.43 | 1.43 | 1.43 | 1.42 | 1.43 | 1.51 | 1.58 | 1. [symbol] 2 | 2.27 |
| 16384 | 16383 | 1.28 | 1.34 | 1.35 | 1.35 | 1.36 | 1.36 | 1.44 | 1.5 [symbol] | 1.75 | 2.21 |

[symbol]

indicates data missing or illegible when filed

What is claimed is:

1. A method of polling a plurality of message data queues in a data processing system, the method comprising:
allocating each of the plurality of queues into one of a plurality of groups, each of the plurality of groups having at least one different attribute;
assigning a polling policy to each of the plurality of groups, each of the polling policies having at least one different requirement than others of the polling policies; and
performing polling of each of the plurality of groups according to its respective polling policy.

2. The method of claim 1, wherein the assigning a polling policy to each of the plurality of groups, each of the polling policies having at least one different requirement than others of the polling policies, comprises assigning a policy to each group which has a different periodicity or frequency of polling as compared to the policies of the other groups.

3. The method of claim 2, wherein the allocating each of the plurality of queues into one of a plurality of groups, each of the plurality of groups having at least one different attribute, comprises allocating each of the plurality of queues into a group based at least on at least one of: (i) historical activity of the queue being allocated, or (ii) projected activity of the queue being allocated.

4. The method of claim 3, wherein the allocating each of the plurality of queues into a group based at least on at least one of: (i) historical activity of the queue being allocated, or (ii) projected activity of the queue being allocated, comprises allocating each of the plurality of queues into a group based at least on write activity of the queue being allocated within at least one of (i) a prescribed historical time period, or (ii) a prescribed number of prior polling iterations.

5. The method of claim 1, wherein the performing the polling of each of the plurality of groups according to its respective polling policy reduces polling relative to a linear or sequential polling scheme without use of the plurality of groups.

6. The method of claim 1, wherein at least the assigning a polling policy to each of the plurality of groups, and the performing polling of each of the plurality of groups according to its respective polling policy, are performed iteratively based at least on one or more inputs relating to configuration of the data processing system.

7. The method of claim 1, wherein the allocating each of the plurality of queues, the assigning a polling policy to each of the plurality of groups, and the performing polling of each of the plurality of groups according to its respective polling policy, are performed at startup of the data processing system based on data descriptive of the data processing system configuration.

8. A method of polling a plurality of message data queues in a data processing system, the method comprising:
allocating each of the plurality of queues into one of a plurality of groups, each of the plurality of groups having at least one flag associated therewith; and
selectively performing polling of the plurality of groups based at least on polling of the at least one flag of each group.

9. The method of claim 8, wherein the selectively performing polling of the plurality of groups based at least on polling of the at least one flag of each group comprises:
polling each queue within a group having a flag set; and
not polling any queues within a group having a flag which is not set.

10. The method of claim 9, wherein the allocating each of the plurality of queues into one of a plurality of groups, each of the plurality of groups having at least one flag associated therewith, comprises allocating each queue into one of the plurality of groups such that each group has an equal number of constituent queues.

11. The method of claim 9, wherein the allocating each of the plurality of queues into one of a plurality of groups, each of the plurality of groups having at least one flag associated therewith, comprises allocating each queue into one of the plurality of groups such that at least some of the plurality of groups have a number of constituent queues different than one or more others of the plurality of groups.

12. The method of claim 9, wherein the allocating each of the plurality of queues into one of a plurality of groups, each of the plurality of groups having at least one flag associated therewith, is based at least in part on one or more of: (i) historical activity of one or more of the queues being allocated, or (ii) projected activity of one or more of the queues being allocated.

13. The method of claim 9, wherein the allocating each of the plurality of queues into one of a plurality of groups, each of the plurality of groups having at least one flag associated therewith, comprises allocating the plurality of queues such that:
a first flag is associated with a first number X of queues; and
a second flag is associated with a second number Y of queues, with X>Y; and
wherein the selectively performing polling of the plurality of groups based at least on polling of the at least one flag of each group comprises, for each group:
polling the first flag of a group; and
based at least on a result of the polling the first flag of the group, selectively polling or not polling the second flag of the group.

14. The method of claim 9, wherein the allocating each of the plurality of queues into one of a plurality of groups, each of the plurality of groups having at least one flag associated therewith, comprises allocating the plurality of queues such that:
a first flag is associated with a first number X of queues; and
a second flag is associated with a second number Y of queues, with X>Y; and
wherein the selectively performing polling of the plurality of groups based at least on polling of the at least one flag of each group comprises:
polling the first flag of each group; and
thereafter, based at least on results of the polling the first flag of each group, selectively polling or not polling the second flag of select ones of the plurality of groups.

15. Computer readable apparatus comprising a storage medium having at least one computer program stored thereon, the at least one computer program configured to, when executed by a processing apparatus of a computerized device, cause the computerized device to efficiently poll a plurality of queues by at least:
assignment of each of a plurality of queues to one of a plurality of groups, each of the plurality of groups having differing values of at least one attribute; and
performance of polling of each of the plurality of groups according to a generated polling policy, the generated polling policy applicable to the plurality of groups such that each group is polled differently from the others based at least on their respective value of the at least one attribute.

16. The computer readable apparatus of claim 15, wherein assignment of each of a plurality of queues to one of a plurality of groups, each of the plurality of groups having differing values of the at least one attribute, comprises further assignment of each of a plurality of queues to one of a plurality of sub-groups within a group, the assignment of each one of a plurality of queues to one of a plurality of sub-groups based at least in part on a value of the at least one attribute associated with that one queue.

17. The computer readable apparatus of claim 15, wherein generation of a polling policy applicable to the plurality of groups such that each group is polled differently from the others based at least on their respective at least one attribute comprises dynamic generation of a backoff parameter for at least one of the plurality of groups, the dynamic generation based at least in part on a number of valid writes detected for queues within the at least one group.

18. The computer readable apparatus of claim 15, wherein the assignment of each of a plurality of queues to one of a plurality of groups comprises:
placement of each of the plurality of queues initially within a first of the plurality of groups;
movement of a given queue of the plurality of queues to a second of the plurality of groups if either 1) data is found on the given queue, or 2) a message is sent to a second queue associated with the given queue.

19. The computer readable apparatus of claim 18, wherein the assignment of each of a plurality of queues to one of a plurality of groups further comprises:
movement of a given queue of the plurality of queues from the second of the plurality of groups to a third of the plurality of groups if the given queue has met one or more demotion criteria.

20. The computer readable apparatus of claim 19, wherein the assignment of each of a plurality of queues to one of a plurality of groups further comprises:
movement of a given queue of the plurality of queues from the third of the plurality of groups to the first of the plurality of groups if the given queue has met one or more second demotion criteria.
